(19) United States
(12) Patent Application Publication
(10) Pub. No.: US 2017/0304881 A1
(43) Pub. Date: Oct. 26, 2017

(54) METHOD OF UTILIZING CONTAMINATED WATER

(71) Applicants: Gregory S. Hein, Katy, TX (US); Sun Yong Kim, Hayward, CA (US)

(72) Inventors: Gregory S. Hein, Katy, TX (US); Sun Yong Kim, Hayward, CA (US)

(21) Appl. No.: 15/496,416

(22) Filed: Apr. 25, 2017

Related U.S. Application Data
(60) Provisional application No. 62/327,054, filed on Apr. 25, 2016.

(51) Int. Cl. B09C 1/02; B01D 17/02

(52) U.S. Cl. CPC B09C 1/02; B01D 17/0214; B09C 2101/00

(57) ABSTRACT

A method of utilizing contaminated water for soil stabilization operations or for the preparation of aggregates for use in asphaltic mix designs. A method where soil is evaluated for a soil typed and characteristic and a classified mixture of contaminated water is selected based on the soil type and characteristics. A reagent is selected based on the soil type and characteristics and the selected water mixture. The reagent and water mixture are then mixed to form a modified calcium hydroxide that is then applied to the soil.

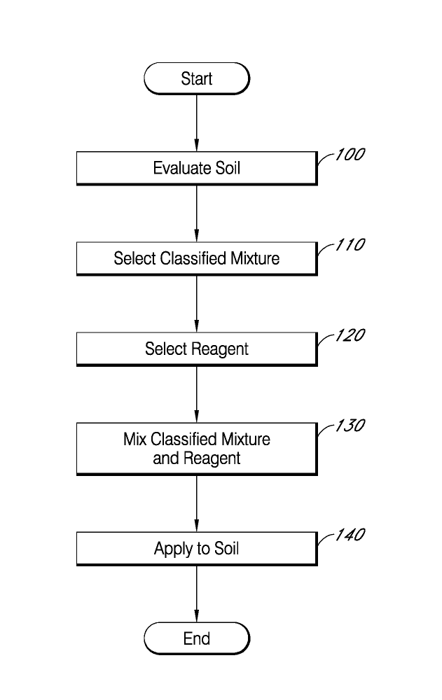

A method where an aggregated is desired to have better adherent qualities within the mix design for better performance is selected and the surface water reduced/removed through the use of a select reagent and contaminated water.

### CROSS REFERENCE TO RELATED APPLICATION

This application claims the benefit of U.S. Provisional Application No. 62/327,054 filed Apr. 25, 2016.

### BACKGROUND OF THE INVENTION

This invention is directed to a method of utilizing contaminated water and more particularly to a method of utilizing contaminated water as a catalyst for a hydration reaction within soil stabilization operations or as water within the process of marinating aggregates within an asphalt pavement mix.

Water becomes contaminated in a number of ways. For example, a contaminant is added to water such as through a chemical spill into a river. Contaminated water also results from water being added to a contaminant such as rain falling into a supply of hydrocarbon. Examples of contaminants include, but are not limited to, used oil, ethanol, petroleum based hydrocarbons, industrial waste waters, brine, animal products, agricultural byproducts and processes, livestock effluent, and the like.

To reuse the contaminated water, the contaminated water must be treated, filtered, mechanically separated or a combination of the various processes which becomes very costly. Where the contaminant is water soluble the contaminant can be completely removed. Otherwise, the contaminant is emulsified in the water and is very difficult to remove.

As one example, water can be contaminated by recycled used oils. When used oil is collected, the used oil typically has a 1% to 5% water content relative to the oil stream. Once collected the used oil is transported to a terminal type location where the used oil is placed within bulk storage tanks. The used oil is left to settle where the used oil rises to the top, the water to the bottom, and the used oil skimmed from the top.

Left after skimming is an oily emulsified water having between 1% to 20% oil. The oily emulsified water is then transferred for further processing using separation technology to retain the maximum value of the used oil. Even after separation, the water still contains a percentage of oil with no beneficial use.

The contaminated water cannot be released into the environment due to the potential hazardous effect on the natural ecosystem. The only option is to transport the contaminated water a long distance to an incinerator or transfer station for disposal. Thus, there is a need in the art for a method of utilizing contaminated water.

Therefore, an objective of the invention is to provide a method of utilizing, rather than disposing, contaminated water.

Another objective of the present invention is to provide a method of utilizing contaminated water that preserves clean drinking water.

A still further objective of the present invention is to provide a method of utilizing contaminated water for a soil stabilization or backflow slurry process.

These and other objectives will be apparent to those skilled in the art based upon the following written description, drawings and claims.

### SUMMARY OF THE INVENTION

A method of utilizing contaminated water begin with evaluating a soil type and soil characteristics. A classified mixture of contaminated water having a defined range of contaminant/water percentage is selected based upon the soil type and characteristics.

Based upon the selected classified mixture of contaminated water and the soil type and characteristics, a reagent is selected. The selected reagent and classified mixture of contaminated water are then mixed to form a modified calcium hydroxide. The modified calcium hydroxide is then applied to the soil.

### BRIEF DESCRIPTION OF THE DRAWING

The FIGURE is a flow diagram of a method of utilizing contaminated water.

### DETAILED DESCRIPTION OF THE PREFERRED EMBODIMENT

Referring to the FIGURE, a method of utilizing contaminated water is shown. By way of example only, the method is shown in relation to a soil stabilization process, but can be used with other applications such as a backflow slurry process, aggregate marination, or the like.

The method begins at step 100 where soil is evaluated, preferably by a soil engineer, to determine the soil type and characteristics.

Based upon the soil type and characteristics, at step 110, a contaminated water mixture is selected from a plurality of classified mixtures with each classified mixture having a defined range of contaminant/water percentage. Next, at step 120, based upon the soil type and characteristics and the selected classified mixture, one or more reagents, such as cement, quick lime, super-hydrated lime, fly ash or the like, and the amount of reagent used are selected.

For example, if the soil type is clay like, lime, because it changes the property of the clay is selected with a classified mixture having a range of functionality compatible with clay and lime. In another example, where the soil is sand, cement may be selected with a classified mixture having a range of functionality compatible with sand and cement.

At step 130 the selected classified mixture and the selected reagent(s) are mixed either on-site or at a plant, or production environment. Mixing the classified mixture and the selected reagent(s) produce a modified calcium hydroxide. Once mixed, the modified calcium hydroxide is applied to the soil in a conventional manner at step 140.

The addition of the modified calcium hydroxide to the soil provides strength and longevity and prevents erosion. Also, the modified calcium increases impermeability in the soil and either confines the contaminant within the impermeable soil matrix and/or binds the contaminant to the surface of the modified calcium hydroxide. Finally, because contaminated water is used for soil stabilization, clean drinking water is preserved. Within the process of marinating aggregates for asphaltic pavements, the aggregate's free water in conjunction with the contaminated water is utilized with the select reagent to increase the adherence of the asphaltic binder to the aggregate mineral free of water.

What is claimed is:

1. A method of utilizing contaminated water for soil stability, comprising the steps of:
evaluating soil to determine soil type and characteristics;
selecting a classified mixture of contaminated water based upon the determined soil type and characteristics;
selecting a classified mixture of contaminated water based upon the determined soil type and characteristics;
selecting a reagent based upon the determined soil type and characteristics and the selected classified mixture of contaminated water;
mixing the selected classified mixture of contaminated water and the selected reagent to form a modified calcium hydroxide; and
applying the modified calcium hydroxide to the evaluated soil.

2. The method of claim 1 wherein the selected reagent is cement.

3. The method of claim 1 wherein the selected reagent is quick lime.

4. The method of claim 1 wherein the selected reagent is super hydrated lime.

5. The method of claim 1 wherein the selected reagent is fly ash.

6. The method of claim 1 wherein the step of mixing occurs on site.

7. The method of claim 1 wherein the step of mixing occurs at a plant.

8. The method of claim 1 further comprising the step of marinating aggregates for asphaltic pavements with the selected reagent
